(19) United States
(12) Patent Application Publication
(10) Pub. No.: US 2022/0309497 A1
(43) Pub. Date: Sep. 29, 2022

(54) CREDIT-BASED ACCESS CONTROL FOR DATA CENTER RESOURCES

(71) Applicant: VMWARE, INC., Palo Alto, CA (US)

(72) Inventors: NAREN LAL, Bangalore (IN); RANGANATHAN SRINIVASAN, Bangalore (IN); NIDHIN URMESE, Bangalore (IN); SRINIVASAN ANGAMUTHU, Bangalore (IN)

(21) Appl. No.: 17/209,278

(22) Filed: Mar. 23, 2021

(51) Int. Cl. G06Q 20/40; H04L 29/08; H04L 29/06; G06Q 40/02

(52) U.S. Cl. CPC G06Q 20/40; H04L 67/32; H04L 63/105; H04L 63/102; G06Q 40/025

(57) ABSTRACT

In an example, a computer implemented method may include assigning credits and a credit limit to a user account. The credit limit may indicate maximum credits that can be used to perform each operation in a data center. Further, the method may include receiving a request to perform an operation on a data center resource from a user associated with the user account. Upon receiving the request, a value corresponding to the requested operation may be retrieved from an attribute associated with the data center resource. Furthermore, the method may include determining whether the user is permitted to perform the requested operation on the data center resource based on available credits of the assigned credits, the credit limit, and the retrieved value. Further, the method may include controlling an access to perform the requested operation based on the determination.

### TECHNICAL FIELD

The present disclosure relates to computing environments, and more particularly to methods, techniques, and systems for controlling access to perform operations on data center resources based on assigned credits.

### BACKGROUND

A data center is a facility that houses a wide range of hardware components such as servers, storage devices, communication equipment, and the like, organized into clusters. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines (VMs), virtual workloads, data compute nodes, clusters, containers, and the like, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of the enterprise without affecting the use of the enterprise's applications. VCIs can be deployed on a hypervisor provisioned with a pool of computing resources (e.g., processing resources, memory resources, and the like). Multiple VCIs can be configured to be in communication with each other in a distributed computing system (e.g., a data center). Such a data center can include various resources/objects such as a server resource, a storage resource, a network resource, a virtual resource, and/or the like.

### BRIEF DESCRIPTION OF THE DRAWINGS

FIG. 1 is a block diagram of an example computing environment, including a management node to control an access to perform a requested operation on a data center resource;

FIG. 2A is an example graphical user interface depicting assignment of credits and a credit limit to a user account;

FIG. 2B is an example graphical user interface depicting associating a value to each type of operation on a data center resource;

FIG. 2C is another example graphical user interface depicting associating the value to each type of operation on the data center resource;

FIG. 2D is an example graphical user interface depicting values corresponding to each type of operation on the data center resource;

FIG. 3 is a flowchart illustrating an example method for controlling an access to perform a requested operation on a data center resource;

FIG. 4 is a flowchart illustrating another example method for controlling an access to perform a requested operation on a data center resource; and

FIG. 5 is a block diagram of an example computing device including non-transitory computer-readable storage medium storing instructions to permit performing a requested operation on a data center resource.

The drawings described herein are for illustration purposes only and are not intended to limit the scope of the present subject matter in any way.

### DETAILED DESCRIPTION

The term “virtual computing instance (VCI)” may cover a range of computing functionality. VCIs may include non-virtualized physical hosts, virtual machines (VMs), and/or containers. Containers can run on a host operating system without a hypervisor or separate operating system, such as a container that runs within Linux. A container can be provided by a VM that includes a container virtualization layer (e.g., Docker). A VM may refer to an isolated user space instance, which can be executed within a virtualized environment. Other technologies aside from hardware virtualization can provide isolated user space instances, also referred to as VCIs. The term “VCI” covers these examples and combinations of different types of VCIs, among others.

The VMs, in some examples, may operate with their own guest operating systems on a host using resources of the host virtualized by virtualization software (e.g., a hypervisor, VM monitor, and the like). The tenant (i.e., the owner of the VM) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VM segregation that may be offered in hypervisor-virtualized environments that virtualize system hardware, and thus can be viewed as a form of virtualization that isolates different groups of applications that operate in different containers.

Multiple VCIs can be configured to be in communication with each other in a distributed computing system (e.g., a software defined data center). Software defined data centers are dynamic in nature. For example, VCI's and/or various application services, may be created, used, moved, or destroyed within the software defined data center. When VCIs are created (e.g., when a container is initialized), various processes and/or services start running and consuming data center resources. As used herein, “data center resources” are physical or virtual components that have a finite availability within a computer or software defined data center. For example, resources include processing resources, memory resources, electrical power, input/output resources, and/or the like.

An example data center resource can be a server resource, a storage resource, a network resource, or a virtual resource in the data center. For example, data center resources may include VMs, host computing devices, clusters, portgroups, resource pools, VM containers for multiple VMs (e.g., vAPP), virtual infrastructure resource management components (e.g., VCD), and/or other VM objects. In some examples, the data center resources can include a combination of software and hardware (e.g., a pool of computing resources) or include hardware configured to perform operations, and control or otherwise manipulate the infrastructure of a distributed computing system (e.g., a cloud environment, a virtualized environment, or the like).

Further, such data centers can be monitored/managed by one or more administrators or an authorized person of an organization/enterprise. For example, an administrator may assign rights to users or other administrators to control access to the data center resources (e.g., to perform one or more operations on the data center resources). In some examples, a role-based access control, which provides access based on permissions, may be used to control the access to the data center resources. For example, a user with a manager role is permitted to access certain data center resources and a user with team lead role is permitted to access different data center resources. In other examples, a scope-based access control, which provides access on resources in a specified range, may be used to control the access to the data center resources. For example, assigning scope 1 to the user may result in only accessing the resources in scope 1.

Furthermore, consider a scenario where the administrator may have to assign a user with an administrator role (e.g., having access to all data center resources) but would want to restrict a set of operations on a critical data center resource. For example, the administrator may assign a user with administrator role but restrict the user from deleting a host (i.e., the data center resource). In order to restrict the set of operations on the data center resource, multiple roles and scopes may have to be assigned to the user. Creating and assigning multiple roles may be a complex and cumbersome process.

Examples described herein may provide a management node to control an access to perform an operation on a data center resource. The management node may assign credits to a user account and also set a credit limit corresponding to the user account. The credit limit may indicate maximum credits that can be used to perform each operation in a data center. Further, the management node may associate an attribute to a data center resource. The attribute may include a value indicating a number of credits to perform each type of operation on the data center resource.

During operation, the management node may receive a request to perform an operation on the data center resource from a user associated with the user account. In response to receiving the request, the management node may manage the request to perform the operation on the data center resource based on the credits and credit limit associated with the user, and the attribute associated with the data center resource. In an example, the management node may permit to perform the operation on the data center resource when available credits of the assigned credits and the credit limit are equal to or greater than a value to perform the operation. In another example, the management node may deny performing the operation on the data center resource when at least one of the available credits and the credit limit is less than the value to perform the operation.

Thus, examples described herein may provide a fine-grained credit-based access control at an operation level on a data center resource and is dynamically configurable. With credits-based access, the administrator can control access provision at finer operation levels on the data center resources to provide enhanced security to the data center resources.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

### System Overview and Examples of Operation

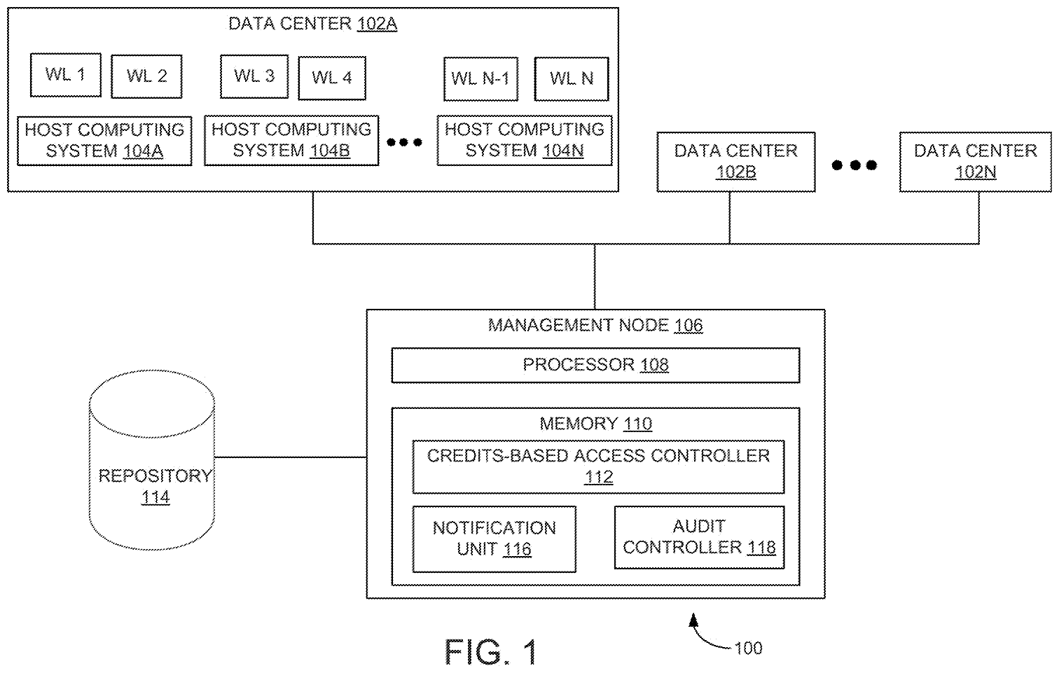

FIG. 1 is a block diagram of an example computing environment 100, including a management node 106 to control an access to perform a requested operation on a data center resource. Example computing environment 100 may include multiple data centers 102A to 102N. A data center may be a physical data center (e.g., an on-premise enterprise computing environment) and/or virtual data center (e.g., a cloud computing environment, a virtualized environment, or the like). The virtual data center may be a pool or collection of cloud infrastructure resources designed for enterprise needs. Further, the virtual data center may be a virtual representation of a physical data center, complete with servers, storage clusters, and networking components, all of which may reside in virtual space being hosted by one or more physical data centers.

As shown in FIG. 1, each data center (e.g., 102A) may include multiple application hosts (e.g., host computing systems 104A to 104N) executing a plurality of applications. Example application host may be a physical computer (e.g., 104A to 104N), a workload (e.g., WL1 to WLN such as a VM, a container, or the like) running on the physical computer, and/or the like. The physical computer may be a hardware-based device (e.g., a personal computer, a laptop, or the like) including an operating system (OS) and executing applications. The VM may operate with its own guest OS on the physical computer using resources of the physical computer virtualized by virtualization software (e.g., a hypervisor, a VM monitor, and the like). The container may be a data computer node that runs on top of a host OS without the need for a hypervisor or separate OS. In some examples, each physical computer 104A to 104N may run a hypervisor that creates and runs VMs.

Further, computing environment 100 may include a management node 106 communicatively connected to data centers 102A to 102N via a network. Example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Example management node 106 may manage different objects/resources in data center 102A to 102N. For example, management node 106 may execute centralized management services that may be interconnected to manage the resources centrally in the virtualized cloud computing infrastructure. Example centralized management service may be a part of vCenter Server™ and vSphere® program products, which are commercially available from Vmware. In an example, a resource may be a server resource, a storage resource, a network resource, a virtual resource, or the like in data center 102A to 102N. For example, the resource may include components in data centers 102A to 102N such as host computing systems 104A to 104N, workloads WL1 to WLN (e.g., virtual machines (VMs), containers, and the like), and the like. In some examples, data center 102A to 102N may be managed by one or more administrators via management node 106.

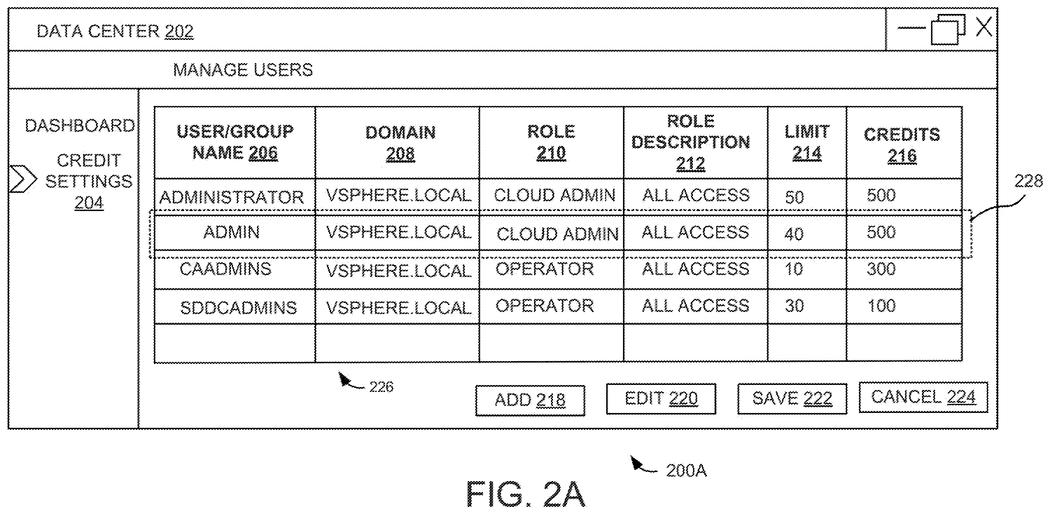

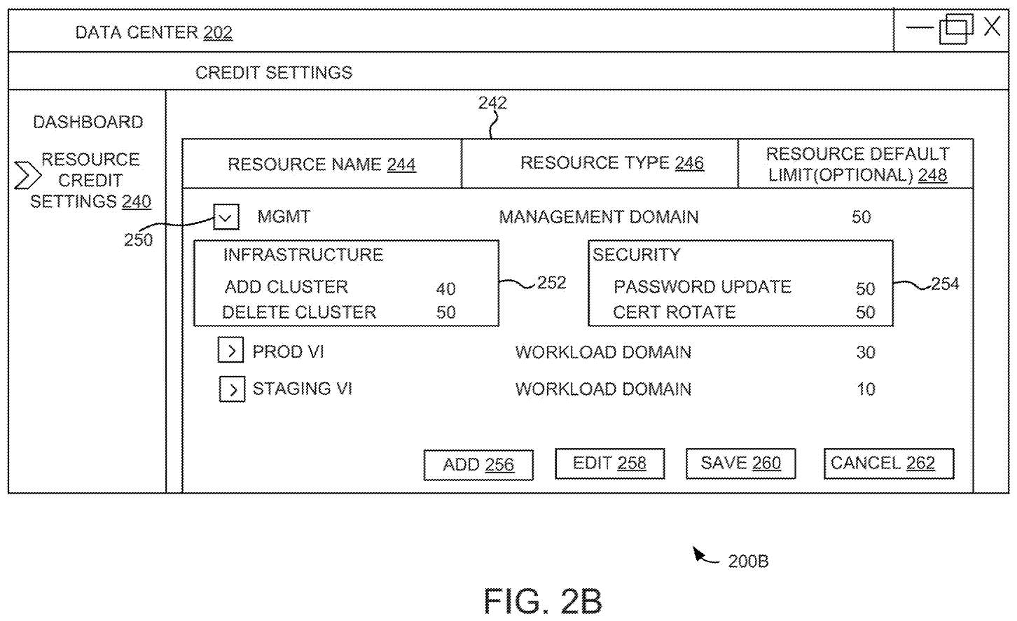

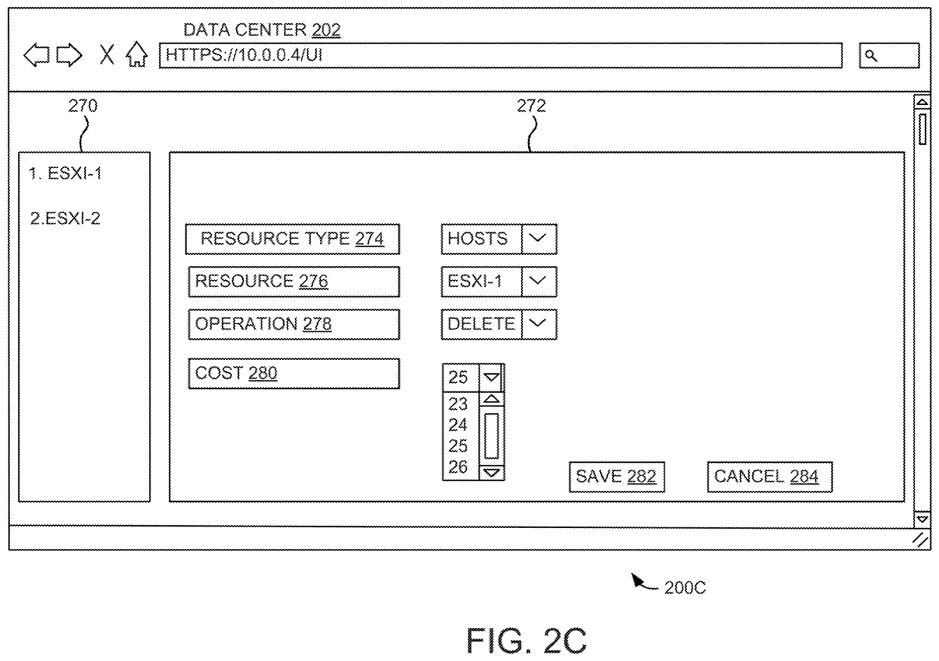

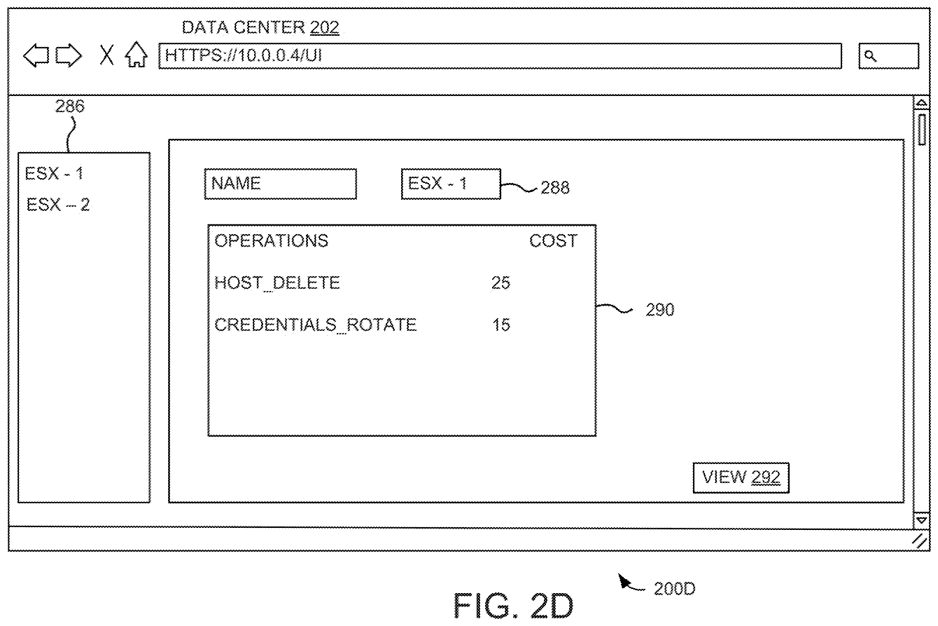

As shown in FIG. 1, management node 106 may include a processor 108 and a memory 110 including a credits-based access controller 112. In an example, credits-based access controller 112 may assign credits to a user account. In some examples, credits-based access controller 112 may set an expiry time for the assigned credits. In this example, the assigned credits may be lapsed upon an expiration of the expiry time. Further, credits-based access controller 112 may set a credit limit corresponding to the user account. The credit limit may indicate maximum credits that can be used to perform each operation in data center 102A to 102N. An example graphical user interface used to assign the credits and the credit limit is depicted in FIG. 2A.

Further, credits-based access controller 112 may associate an attribute to a data center resource. In an example, the attribute may include a value indicating a number of credits to perform each type of operation on the data center resource. An example graphical user interface used to associate the attribute to the data center resource is depicted in FIGS. 2B and 2C. As shown in FIG. 1, computing environment 100 may include a repository 114 to store the assigned credits, available credits, and the credit limit associated with the user account. Further, repository 114 may store the attribute associated with the data center resource. In an example, repository 114 may reside external to management node 106 and accessible to management node 106 (e.g., as shown in FIG. 1). In another example, repository 114 may reside within management node 106. Example repository 114 may be a database either embedded within vCenter or external to vCenter, a flat file, or the like.

During operation, credits-based access controller 112 may receive a request to perform an operation on the data center resource from a user associated with the user account. Further, credits-based access controller 112 may determine whether the user is permitted to perform the requested operation on the data center resource based on available credits of the assigned credits, the credit limit, and the value to perform the operation.

Further, credits-based access controller 112 may control an access to perform the requested operation based on the determination. In an example, credits-based access controller 112 may permit the request to perform the operation on the data center resource when the available credits of the assigned credits and the credit limit are equal to or greater than the value to perform the operation.

In another example, credits-based access controller 112 may deny the request to perform the operation on the data center resource when at least one of the available credits and the credit limit is less than the value to perform the operation. In an example, memory 110 may include a notification unit 116 to send a notification to the user upon denying the request to perform the operation. An example notification may indicate a reason (e.g., less credits or less credit limit) for denying the request. Furthermore, memory 110 may include an audit controller 118 to maintain an audit trail to record the information corresponding to actions of the user to access the data center resource, a way in which the credits associated with the user is utilized, and the like.

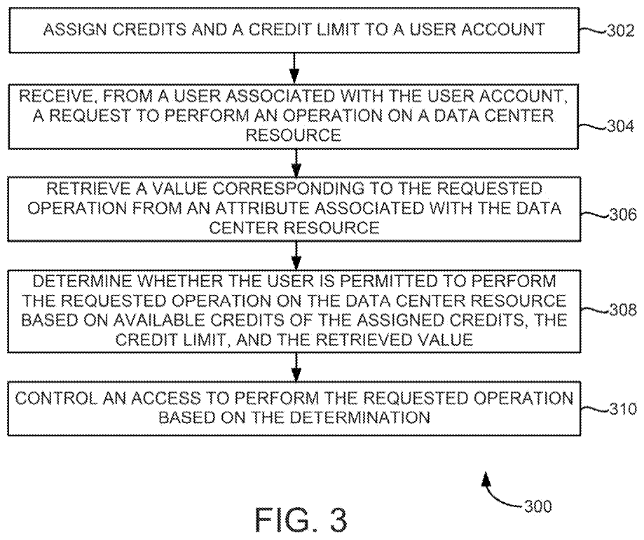

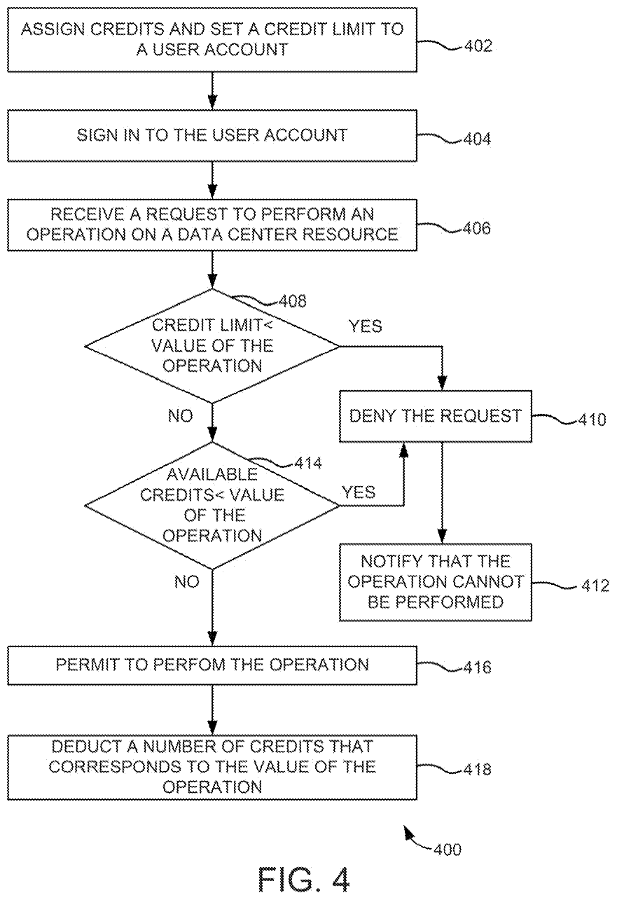

Further, upon performing the operation on the data center resource, credits-based access controller 112 may deduct a number of credits that corresponds to the value from the available credits. Further, the credits-based access controller 112 may reassign the credits to the user account upon receiving a request for a credit from the user or at regular intervals of time. An example method for reassigning the credits is described in FIGS. 3 and 4.

In other examples, the administrator may set certain operations such as “restore software defined data center (SDDC)” as “credits exhausting operations”. In this example, when a user performs a credit exhausting operation (e.g., considering that the user has enough credit limit to execute such operation), the available credits of the user may be exhausted. Further, exhausting the available credits may prevent the user from performing such operations (e.g., restoration of the SDDC) more than once as restoring is a critical operation. Further, notification unit 116 may notify the administrator to indicate the execution of the restoration operation by the user.

In some examples, the functionalities described in FIG. 1, in relation to instructions to implement functions of credit-based access controller 112, notification unit 116, audit controller 118, and any additional instructions described herein in relation to the storage medium, may be implemented as engines or modules including any combination of hardware and programming to implement the functionalities of the modules or engines described herein. The functions of credit-based access controller 112, notification unit 116, and audit controller 118 may also be implemented by a respective processor. In examples described herein, the processor may include, for example, one processor or multiple processors included in a single device or distributed across multiple devices.

FIG. 2A is an example graphical user interface 200A depicting assignment of credits 216 and a credit limit 214 to a user account (e.g., 206). Example graphical user interface 200A may correspond to data center 202 providing a credit setting option 204. Using credit setting option 204, an administrator or authorized person of an organization may set credits 216 and credit limit 214 to a user or a group of users 206. As shown in FIG. 2A, a table 226 may depict username 206, a corresponding domain 208, a role 210 assigned to the user, role description 212, credit limit 214, and credits 216. In an example, the user may perform any operation on data center resources based on available credits in user's account, credit limit 214 as set by the administrator, and associated role 210.

For example, table 226 may depict that a user “admin” is provided with credits “500” and credit limit “40” as shown in 228. Thus, “admin” may perform any operation on the data center resources which costs less than or equal to “40” credits. Further, the administrator may modify table 226 by adding new user using an add option 218, modifying details using an edit option 220, and the like. Furthermore, graphical user interface 200A may provide options such as save 222 to save the changes, cancel 224 to discard the changes, and the like to maintain table 226.

FIG. 2B is an example graphical user interface 200B depicting associating a value to each type of operation on a data center resource. Example graphical user interface 200B may correspond to data center 202. Further, graphical user interface 200B may provide a resource credit setting option 240, for instance, in a menu bar. Using resource credit setting option 240, an administrator or authorized person of an organization may configure values or costs to each operation on the data center resource.

In response to selection of credit setting option 240, example graphical user interface 200B may provide a portion 242 to display a list of data center resource names 244, corresponding resource types 246, and a resource default limit 248 (e.g., a default value for each resource). Further, a data center resource may be selected using corresponding drop-down menus (e.g., 250). In the example shown in FIG. 2B, the data center resource “MGMT” is selected using drop-down menu 250. Further, credits to different operations corresponding to infrastructure (e.g., 252) and security (e.g., 254) of “MGMT” resource may be assigned as shown in FIG. 2B. In the example shown in FIG. 2B, operations corresponding to infrastructure 252 such as “add cluster” is assigned 40 credits, “delete cluster” is assigned 50 credits, and so on. Thus, each data center resource may include a new attribute that contains cost for each type of operation (e.g., edit, delete, add, and the like) on them. Different data center resources (e.g., PROD VI, STAGING VI, and the like) may be associated with different values of attributes.

Further, the administrator may modify the credits for data center 202 by adding new data center resources using an add option 256, modifying credits using an edit option 258, and the like. Furthermore, graphical user interface 200B may provide options such as save 260 to save the changes, cancel 262 to discard the changes, and the like to maintain credits for the data center resources.

FIG. 2C is another example graphical user interface 200C depicting associating the value to each type of operation on the data center resource. Example graphical user interface 200C may correspond to data center 202. Example graphical user interface 200C may provide a first portion 270 to display available data center resources (e.g., enterprise-class, type-1 hypervisor (ESXI) 1 and ESXI 2) corresponding to data center 202. Further, graphical user interface 200C may display a second portion 272 including multiple options to select data center resources and assign values to various operations on the data center resources. In the example shown in FIG. 2C,
a resource type option 274 may allow an administrator to select a resource type, e.g., “hosts”.
a resource option 276 may allow the administrator to select a resource, e.g.,

“ESXI-1”.
an operation option 278 may allow the administrator to select an operation (e.g., “delete”) corresponding to the data center resource “ESXI-1”.
a cost option 280 may allow the administrator to assign value to the selected operation (e.g., “delete”).

Thus, the administrator can assign values for various operations (e.g., add, delete, edit, and the like) associated with various data center resources. Further, the administrator may save the assignment of values using a save option 282, discard any changes to the values using a cancel option 284, and the like.

FIG. 2D is an example graphical user interface 200D depicting values corresponding to each type of operation on the data center resource. Example graphical user interface 200D may correspond to data center 202. Example graphical user interface 200D may provide a first portion 286 to display available data center resources corresponding to data center 202. Further, a user may select one of the data center resource (e.g., ESXI-1) (e.g., 288). Upon selecting the data center resource, a second portion 290 may be displayed, where the operations (e.g., delete, rotate, and the like) and corresponding values (i.e., a number of credits) may be displayed as shown in FIG. 2D. Thus, the user can visualize the data center resource configuration from one place.

### Example Processes

FIG. 3 is a flowchart illustrating an example method 300 for controlling an access to perform a requested operation on a data center resource. At 302, credits and a credit limit may be assigned to a user account. In an example, the credit limit may indicate maximum credits that can be used to perform each operation in a data center. In an example, assigning the credits and the credit limit to the user account may include:
assigning at least one of a role-based access control and a scope-based access control to the user account, and
assigning the credits and the credit limit per operation to the user account upon assigning at least one of the role-based access control and the scope-based access control.

For example, an administrator may assign or grant “300” credits to the user for regular operations. Further, the administrator may set a credit limit of “20” for the user. Also, an expiry time to utilize the assigned credits associated with the user account may be set. Thus, the user may not be able to execute any operation that costs more than “20” credits. Further, the user can perform all the operations within his role or scope permissions except those incur cost more than “20” credits.

At 304, a request to perform an operation on a data center resource may be received from the user associated with the user account. At 306, a value corresponding to the requested operation may be retrieved from an attribute associated with the data center resource. The retrieved value may indicate a number of credits to perform the requested operation. Further, the value defined in the attribute is configurable. In an example, retrieving the value corresponding to the requested operation may include:
retrieving the attribute associated with the data center resource from an attribute repository, and
retrieving the value corresponding to the requested operation from the retrieved attribute.

At 308, a check may be made to determine whether the user is permitted to perform the requested operation on the data center resource based on available credits of the assigned credits, the credit limit, and the retrieved value. At 310, an access to perform the requested operation may be controlled based on the determination.

In an example, controlling the access to perform the requested operation may include restricting the access to perform the requested operation on the data center resource in response to a determination that the available credits or the credit limit is less than the retrieved value. For example, consider the available credits are “300”, the credit limit is “20”, and the retrieved value is “30”. In this example, the access to perform the requested operation is restricted as the credit limit (i.e., “20” credits) is less than the retrieved value (i.e., “30” credits). In another example, consider the available credits are “20”, the credit limit is “40”, and the retrieved value is “30”. In this example, the access to perform the requested operation is restricted as the available credits (i.e., “20” credits) is less than the retrieved value (i.e., “30” credits).

In another example, controlling the access to perform the requested operation may include permitting the access to perform the requested operation on the data center resource in response to a determination that the available credits and the credit limit are equal to or greater than the retrieved value. For example, consider the available credits are “300”, the credit limit is “20”, and the retrieved value is “15”. In this example, the access to perform the requested operation is permitted as the credit limit (i.e., “20” credits) is greater than the retrieved value (i.e., “15” credits) and also the available credits (i.e., “300” credits) is greater than the retrieved value (i.e., “15” credits). Further, a number of credits that corresponds to the retrieved value may be deducted from the available credits associated with the user account upon performing the requested operation on the data center resource. In this example, the credits corresponding to the retrieved value, i.e., “15” credits are deducted from the available credits, i.e., “300” credits. Thus, updated available credits are “285”.

Further, example method 300 may include determining that the assigned credits are utilized in accordance with an organization policy, for instance, at regular intervals or upon receiving a request. Based on the determination, the credits may be reassigned to the user account. Furthermore, example method 300 may include obtaining an audit record of the user's transactions associated with a utilization of the assigned credits periodically or upon the available credits fall below a threshold. Thus, examples described herein may be implemented either independently of a role-based access control and a scope-based access control. Also, examples described herein may be implemented seamlessly along with the role-based access control and/or the scope-based access control to enhance user experience.

FIG. 4 is a flowchart illustrating another example method 400 for controlling an access to perform a requested operation on a data center resource. At 402, credits and a credit limit may be assigned to a user account by an administrator or an authorized person of an organization. For example, the administrator may grant “300” credits to the user for user's regular operations. Further, when certain operations (e.g., a password rotate operation) on the data center resource may have to be prevented, the administrator may set a credit limit of “20” for the user and assign a value (e.g., “25” credits) greater than “20” for password rotate operation (e.g., in management Vcenter). Thus, the user cannot execute the password rotate operation or any operation that costs more than “20” credits even though the user is having administrator role. By setting the credits and the credit limit, the administrator can prevent any changes to critical data center resources from the users.

At 404, the user may sign-in to the user account. For example, the user may sign-in to the account using corresponding username and unique password. At 406, the user may request to perform an operation on a data center resource.

At 408, a check may be made to determine whether the credit limit associated with the user is less than a value associated with the operation. When the credit limit is less than the value, the request may be denied, at 410. Further, a notification may be sent to the user that the operation may not be performed as the credit limit is less corresponding to the operation, at 412. In this example, the user may request the administrator to increase the credit limit to perform the operation. Further, the administrator may analyze whether the user can perform the operation and act on the request.

When the credit limit is equal to or greater than the value, a check may be made to determine whether available credits associated with the user is less than the value associated with the operation, at 414. When the available credit is less than the value, the request may be denied, at 410. Further, a notification may be sent to the user that the operation may not be performed as the credits are less corresponding to the operation, 412. In this example, the user may request the administrator for additional credits to perform the operation. Further, the administrator may analyze whether the user can perform the operation and act on the request.

When the available credits are equal to or greater than the value, the user may be permitted to perform the operation, at 416. At 418, a number of credits corresponding to the value of the operation may be deducted from the available credits.

For example, the administrator may grant “500” credits to the user for regular operations and set the credit limit of “20” for the user. Thus, the user may not be able to execute any operation that costs more than “20” credits. Further, the user can perform all the operations within his role permissions except those incur cost more than “20”. When the user exhausts all the credits, the user may request for more credits from the administrator. In another example, the administrator can set up auto re-fill based on a condition such as when “500” credits are exhausted over a period of 6 months. Similarly, the administrator may set that auto-refill to not happen when the credits exhaust within 15 days.

Further, the administrator may monitor the actions of the user by obtaining an audit of the user transactions through credits history which will be useful while reassigning the credits to the user. Thus, examples described herein may provide the administrator with operational level access control on the data center resources. Further, when examples described herein is used in conjunction with a role-based access control and a scope-based access control, a need of creating a new custom roles and scopes may be eliminated.

It should be understood that the process depicted in FIGS. 3 and 4 represent generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

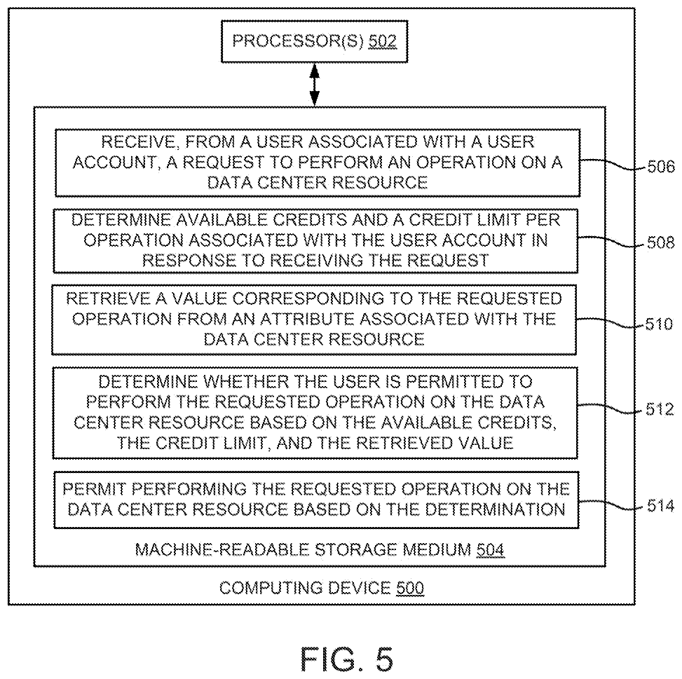

FIG. 5 is a block diagram of an example computing device 500 including non-transitory computer-readable storage medium 504 storing instructions to permit performing a requested operation on a data center resource. Computing device 500 (e.g., management node 106 of FIG. 1) may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504.

Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 504 may be a non-transitory machine-readable medium. In an example, machine-readable storage medium 504 may be remote but accessible to computing device 500.

Machine-readable storage medium 504 may store instructions 506-514. In an example, instructions 506-514 may be executed by processor 502 to permit performing a requested operation on a data center resource. Instructions 506 may be executed by processor 502 to receive, from a user associated with a user account, a request to perform an operation on a data center resource.

Instructions 508 may be executed by processor 502 to determine available credits and a credit limit per operation associated with the user account in response to receiving the request. Instructions 510 may be executed by processor 502 to retrieve a value corresponding to the requested operation from an attribute associated with the data center resource. The retrieved value may indicate a number of credits to perform the requested operation.

Instructions 512 may be executed by processor 502 to determine whether the user is permitted to perform the requested operation on the data center resource based on the available credits, the credit limit, and the retrieved value. Instructions 514 may be executed by processor 502 to permit performing the requested operation on the data center resource based on the determination. In an example, instructions to permit to perform the requested operation may include instructions to permit to perform the requested operation on the data center resource in response to a determination that the available credits and the credit limit are equal to or greater than the retrieved value.

In another example, machine-readable storage medium 504 may store instructions to be executed by processor 502 to deny performing the requested operation on the data center resource in response to a determination that the available credits or the credit limit is less than the retrieved value.

Machine-readable storage medium 504 may further store instructions to be executed by processor 502 to assign at least one of a role-based access control and a scope-based access control to the user account in response to receiving a first request. Further, instructions may assign an amount of credits and the credit limit per operation to the user account in response to receiving a second request and upon assigning at least one of the role-based access control and the scope-based access control.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

A computer implemented method comprising:
assigning credits and a credit limit to a user account, wherein the credit limit is to indicate maximum credits that can be used to perform each operation in a data center;
receiving, from a user associated with the user account, a request to perform an operation on a data center resource;
retrieving a value corresponding to the requested operation from an attribute associated with the data center resource, wherein the retrieved value is to indicate a number of credits to perform the requested operation;
determining whether the user is permitted to perform the requested operation on the data center resource based on available credits of the assigned credits, the credit limit, and the retrieved value; and
controlling an access to perform the requested operation based on the determination.

2. The computer implemented method of claim 1, wherein controlling the access to perform the requested operation comprises:
restricting the access to perform the requested operation on the data center resource in response to a determination that the available credits or the credit limit is less than the retrieved value.

3. The computer implemented method of claim 1, wherein controlling the access to perform the requested operation comprises:
permitting the access to perform the requested operation on the data center resource in response to a determination that the available credits and the credit limit are equal to or greater than the retrieved value.

4. The computer implemented method of claim 3, further comprising:
deducting a number of credits that corresponds to the retrieved value from the available credits associated with the user account upon performing the requested operation on the data center resource.

5. The computer implemented method of claim 1, wherein retrieving the value corresponding to the requested operation comprises:
retrieving the attribute associated with the data center resource from an attribute repository; and
retrieving the value corresponding to the requested operation from the retrieved attribute, wherein the value defined in the attribute is configurable.

6. The computer implemented method of claim 1, wherein assigning the credits and the credit limit to the user account comprises:
assigning at least one of a role-based access control and a scope-based access control to the user account; and
assigning the credits and the credit limit per operation to the user account upon assigning at least one of the role-based access control and the scope-based access control.

7. The computer implemented method of claim 1, further comprising:
determining that the assigned credits are utilized in accordance with an organization policy; and
reassigning the credits to the user account in response to the determination.

8. The computer implemented method of claim 1, further comprising:
setting an expiry time to utilize the assigned credits associated with the user account.

9. The computer implemented method of claim 1, further comprising:
obtaining an audit record of the user's transactions associated with a utilization of the assigned credits periodically or upon the available credits fall below a threshold.

10. A management node comprising:
a processor; and
a memory comprising a credits-based access controller to:
assign credits to a user account;
set a credit limit corresponding to the user account, wherein the credit limit to indicate maximum credits that can be used to perform each operation in a data center;
associate an attribute to a data center resource, wherein the attribute is to include a value indicating a number of credits to perform each type of operation on the data center resource;
receive, from a user associated with the user account, a request to perform an operation on the data center resource; and
permit the request to perform the operation on the data center resource when available credits of the assigned credits and the credit limit are equal to or greater than a value to perform the operation.

11. The management node of claim 10, wherein the credits-based access controller is to:
deduct a number of credits that corresponds to the value from the available credits upon performing the operation.

12. The management node of claim 10, wherein the credits-based access controller is to:
deny the request to perform the operation on the data center resource when at least one of the available credits and the credit limit is less than the value to perform the operation.

13. The management node of claim 10, further comprising:
a repository to store:
the assigned credits, the available credits, and the credit limit associated with the user account; and
the attribute associated with the data center resource.

14. The management node of claim 10, wherein the credits-based access controller is to:
reassign the credits to the user account upon receiving a request for a credit from the user or at regular intervals of time.

15. The management node of claim 10, wherein the credits-based access controller is to:
set an expiry time for the assigned credits, wherein the assigned credits will be lapsed upon an expiration of the expiry time.

16. The management node of claim 10, wherein the data center resource comprises a server resource, a storage resource, a network resource, or a virtual resource in the data center.

17. A non-transitory machine-readable storage medium encoded with instructions that, when executed by a processor of a computing device, cause the processor to:
receive, from a user associated with a user account, a request to perform an operation on a data center resource;
determine available credits and a credit limit per operation associated with the user account in response to receiving the request;
retrieve a value corresponding to the requested operation from an attribute associated with the data center resource, wherein the retrieved value is to indicate a number of credits to perform the requested operation;
determine whether the user is permitted to perform the requested operation on the data center resource based on the available credits, the credit limit, and the retrieved value; and
permit performing the requested operation on the data center resource based on the determination.

18. The non-transitory machine-readable storage medium of claim 17, further comprising instructions that, when executed by the processor, cause the processor to:
deny performing the requested operation on the data center resource in response to a determination that the available credits or the credit limit is less than the retrieved value.

19. The non-transitory machine-readable storage medium of claim 17, wherein instructions to permit to perform the requested operation comprise instructions to:
permit to perform the requested operation on the data center resource in response to a determination that the available credits and the credit limit are equal to or greater than the retrieved value.

20. The non-transitory machine-readable storage medium of claim 17, further comprising instructions to:
assign at least one of a role-based access control and a scope-based access control to the user account in response to receiving a first request; and
assign an amount of credits and the credit limit per operation to the user account in response to receiving a second request and upon assigning at least one of the role-based access control and the scope-based access control.
